(19) United States
(12) Patent Application Publication
(10) Pub. No.: US 2002/0165774 A1
(43) Pub. Date: Nov. 7, 2002

(54) Offline-to-online traffic generation and demographic identification process and method

(76) Inventors: Gaellen D. Quinn, Cedar Park, TX (US); Michael J. Quinn, Cedar Park, TX (US)

Correspondence Address: GRAY, CARY, WARE & FREIDENRICH LLP, 1221 SOUTH MOPAC EXPRESSWAY, SUITE 400, AUSTIN, TX, 78746-6875, US

(21) Appl. No.: 10/063,605

(22) Filed: May 3, 2002

Related U.S. Application Data
(60) Provisional application No. 60/288,487, filed on May 3, 2001.

(51) Int. Cl. G06F 17/60

(52) U.S. Cl. 705/14

(57) ABSTRACT

Systems and methods for disseminating information in a manner that increases the reach of the information. In one embodiment, a plurality of relatively small advertisements are positioned in an advertising layout. This layout is published concurrently in a number of magazines which are preferably directed to people having similar interests and demographics. A replica of the layout is also provided on a web page. The advertisements in the layout comprise selectable objects that are linked to additional information relating to the respective advertisements.

### CROSS REFERENCE TO RELATED APPLICATIONS

This application claims priority from U.S. Provisional Patent Application No. 60/288,487, entitled Offline-To-Online Traffic Generation And Demographic Identification Process And Method, filed May 3, 2001 by Gaellen Quinn and Michael J. Quinn, which application is incorporated by reference as if set forth herein in its entirety.

### BACKGROUND OF THE INVENTION

### FIELD OF THE INVENTION

The invention relates generally to the dissemination of information to large numbers of people and more particularly to systems and methods for maximizing the reach of advertising layouts in one medium and using these advertising layouts to drive traffic to a source of information embodied in another medium.

### BACKGROUND

The goal of advertising is to disseminate information to people. Typically, the information relates to a product or service that a provider wishes to sell. Naturally, the provider wishes to get this information to as many potential consumers as possible. These potential consumers may consist of the general populace, or a more specific demographic group. The number of consumers who may see the information is referred to as the reach of the advertising layout through which the information is disseminated.

Normally, as advertising reach increases, so does the cost associated with the advertising. For example, advertising can reach more people if it is placed in several media than if it is placed in a single medium. It is more expensive, however, to increase the number of media in which the ad is published. Similarly, an advertising layout is normally expected to reach more people if it is larger in size than if it is smaller. Again, it is more expensive to place the larger ad and to reach the greater number of people. It would be desirable to have a means for increasing the reach of advertising without increasing the corresponding cost.

The role of cross-media advertising is also significant in reaching the consuming public. Many providers of goods and services now maintain a presence on the Internet and use this presence (their web sites) to advertise in addition to more traditional marketing channels, such as print advertising. The effectiveness (including cost-effectiveness) of a provider's advertising may be increased by the ability to cause consumers who view advertising layouts in one medium to also view advertising layouts or related information on another medium. It would therefore be desirable to have a means for driving this cross-media traffic.

### SUMMARY OF THE INVENTION

One or more of the problems outlined above may be solved by the various embodiments of the invention. Broadly speaking, the invention comprises systems and methods for disseminating information in a manner that increases the reach of the information. In one embodiment, a plurality of relatively small advertisements are positioned in an advertising layout. This layout is published concurrently in a number of magazines which are preferably directed to people having similar interests and, consequently, similar demographics. Because the reach of a particular advertisement increases in proportion to the increased readership, but does not decrease in proportion to the reduced size of the advertisement, the reach per unit cost increases. The reach is also increased by the added impact of the accompanying individual advertisements in the layout.

In another embodiment, information is published in a first medium, such as magazines, and this information is used to drive traffic to a second medium, such as the Internet, where people can obtain additional information. In this embodiment, small advertisements are again positioned together in a printed advertising layout that is published concurrently in a number of magazines directed to people having similar demographics. The advertising layout directs readers to go to a web site which displays a replica of the printed advertising layout. The small advertisements within the layout are each linked (e.g., hyperlinked) to additional information, such as the respective advertisers' homepages, special offers, or other information related to the advertisements. This system may further increase the reach of the advertisers in relation to the foregoing embodiment because it may provide the readers with more readily accessible information than could otherwise be provided in a small advertisement.

In another embodiment, a system in which readers of a printed advertising layout are directed to a corresponding web-based layout may provide advertisers with immediate demographic information on the visitors to their web site. Using a system similar to the one described in the foregoing paragraph, readers may be given a code or identifier and directed to input this identifier in response to a prompt at the web site. The identifier may be associated with the entire group of related-interest magazines, or with an individual magazine, or both. When the reader/web site visitor enters the identifier, the reader can immediately be identified as a reader of the corresponding magazine or printed publication and can therefore be assumed to be within the demographic representative of the magazine's readership. The web site can then customize the presentation or content of the web pages requested by the reader according to the demographic information.

Another embodiment may comprise a method implemented by one of the above-described systems. Still other embodiments may comprise software applications that are configured to implement these methods. These software applications are embodied in computer-readable media such as floppy disks, CD-ROMs, DVD-ROMs, RAM, ROM, database schemas and the like. The computer readable media contain instructions which are configured to cause a computer to execute the methods which are described herein. It should be noted that the computer readable medium may comprise a RAM or other memory which forms part of a computer system. The computer system would thereby be enabled to perform a method in accordance with the present disclosure and is believed to be within the scope of the appended claims.

Numerous additional embodiments are also possible.

### BRIEF DESCRIPTION OF DRAWINGS

Other objects and advantages of the invention may become apparent upon reading the following detailed description and upon reference to the accompanying drawings.

FIG. 1 is a top-level flow diagram illustrating the basic steps of the method in a preferred embodiment of the invention.

FIG. 2 is an advertising layout comprising a plurality of small advertising layouts which is followed by a plurality of printed advertising layouts and a web-based advertising layout in one embodiment of the invention.

FIG. 3 is a diagram illustrating an overview of the system of one embodiment.

FIG. 4 is an illustration of a computer displaying the homepage for a web site in one embodiment.

FIG. 5 is an illustration of the advertisement objects that make up a portion of the advertising layout in one embodiment.

FIG. 6 is an illustration of the advertisement objects that make up a portion of the advertising layout in an alternative embodiment.

While the invention is subject to various modifications and alternative forms, specific embodiments thereof are shown by way of example in the drawings and the accompanying detailed description. It should be understood, however, that the drawings and detailed description are not intended to limit the invention to the particular embodiment which is described. This disclosure is instead intended to cover all modifications, equivalents and alternatives falling within the scope of the present invention as defined by the appended claims.

### DETAILED DESCRIPTION

A preferred embodiment of the invention is described below. It should be noted that this and any other embodiments described below are exemplary and are intended to be illustrative of the invention rather than limiting.

Broadly speaking, the invention comprises systems and methods for information. In one embodiment, information is published in a first medium, such as magazines, and this information is used to drive traffic to a second medium, such as the Internet, where people can obtain additional information. In this embodiment, a plurality of relatively small advertisements are positioned in an advertising layout. This layout is published concurrently in a number of magazines which are preferably directed to people having similar interests and, consequently, similar demographics. The advertising layout directs readers to go to a web site which displays a replica of the printed advertising layout. The small advertisements within the layout are each linked (e.g., hyperlinked) to additional information, such as the respective advertisers' homepages, special offers, or other information related to the advertisements. This system may increase the reach of the advertisers in relation to the cost of the advertisements because the advertising layout (hence each advertisement) appears concurrently in a plurality of magazines. The system may also provide the readers more readily accessible information than could otherwise be provided in a small advertisement. The system may also provide the advertisers with an increased amount of demographic information on the people who visit the web site because the visitors may be identified as originating from advertising layouts in the special-interest group of magazines.

The present systems and methods may provide a means for businesses to use media in specific ways to lower the cost and extend the reach of advertising, and to amplify the effect of both large and small advertising messages by creating a bridge from print media to the Internet. They may also generate web traffic by allowing users to access specific advertising offers on the web which they first see off-line. They may further provide an improved means for gathering demographic information about users who access particular web sites. The present systems and methods may also provide a means for maintaining relational databases and processes for analyzing data gathered for individual users and offering these users particular services, advertising messages or other information based upon the collected information corresponding to those users.

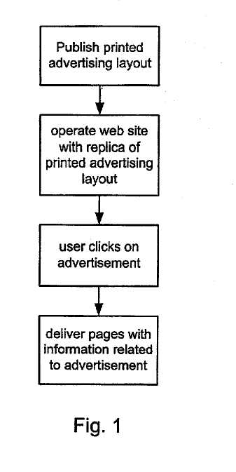

Referring to FIG. 1, a top-level flow diagram illustrating the basic steps of the method in a preferred embodiment of the invention is shown. In this embodiment, the method generally comprises the steps of publishing a print advertising layout, concurrently providing a web site configured to present users with an image replicating the print advertising layout, accepting user input in the form of selecting a linked object (e.g., image or text) corresponding to a portion of the print advertising layout, and presenting users with information corresponding to the selected object.

In the preferred embodiment, the print advertising layout is published in a network of magazines. The advertising layout is essentially identical in each of the magazines, although a specific identifier corresponding to the particular magazine in which the advertising layout is published is included in the layout. The network of magazines is contemplated to include a number of related publications which are directed to persons having a common set of interests. For example, the advertising layout may be published in a network of business magazines (e.g., Forbes, Red Herring, Fortune, etc.) or in a network of magazines directed to women (e.g., Women's Day, Ladies Home Journal, etc.) Because the advertising layout is published in a network of related magazines, it can be assumed that traffic which is driven to the web site from these magazines comprises people within an identifiable demographic. The corresponding demographic information can then be used to tailor the web pages, images, information and so on which are presented to the particular demographic to which the user is assumed to belong.

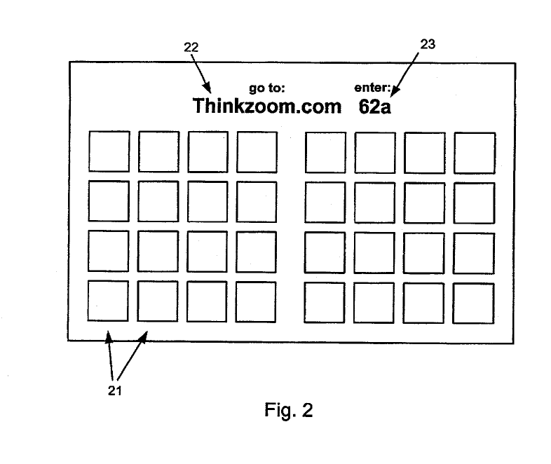

In the preferred embodiment, the print advertising layout and the corresponding replica on the web site comprise a plurality of small advertisements as illustrated in FIG. 2. (In other embodiments, the print advertisements may comprise something as simple as text which may be highlighted and underlined to indicate a correspondence to a URL.) Each of these small advertisements 21 corresponds to a particular advertiser. The purpose of using this arrangement of small advertisements is to minimize the cost to each of the individual advertisers which are included in the larger advertising layout, but to maximize the exposure of the advertisers to readers. Each advertiser pays only for the space occupied by that advertiser's small advertisement within the larger advertising layout.

Traditionally, advertisers have assumed that the only way to increase the message impact of an advertisement is by increasing the size of the advertisement. The present methods, however, make use of the greater cost-effectiveness of groupings of small advertisements by taking the money that would have been spent on a large advertisement and instead placing a number of small advertisements in different publications. With the greater reach of smaller advertisements in a larger number of publications, the number of people reached by an advertisement for each dollar spent can be dramatically increased. It has been determined empirically that, while larger advertisements attract more attention and consequently have more message impact (the number of people who see the advertisement) than smaller advertisements standing alone, the message impact of the advertisement does not increase at the same rate the cost increases. Thus, the amount of message impact per dollar spent on an advertisement is actually greater for smaller advertisements. The use of smaller advertisements in a number of publications therefore maximizes the reach of the advertisements per dollar spent. Moreover, the message impact of each of the smaller advertisements is increased by grouping several of them together to cover a larger area than each advertisement would occupy individually. The grouping of smaller advertisements in clusters therefore increases the message impact of the advertisements per dollar spent.

Taken together, the effects of using smaller advertisements and grouping these advertisements together substantially increase the effectiveness of the corresponding advertising investments. Effectively, this combination of mechanisms creates advertising efficiency which is greater than the sum of the parts. This can be illustrated using the following example.

If an entity such as an advertising cooperative purchases a certain amount of advertising space in a certain number of publications (e.g., a full page in each of nine magazines,) a corresponding cost will be incurred (i.e., the cost of the full page in each of the magazines.) this advertising space can be distributed among the advertisers in the cooperative in a number of ways. For example, if there are nine advertisers in the cooperative, each can have a single, full-page advertisement in one of the magazines. Alternatively, each can have an advertisement which takes up one ninth of a page (e.g., an advertisement one third of the height and one third of the width of the full-page advertisement) in each of the nine magazines. If each advertiser's advertisement stood alone in each magazine, it would have more than one ninth of the message impact of the full-page advertisement (as discussed above) and nine times the reach of the single, full-page advertisement. Thus it would be more effective than the full-page advertisement. If, instead of standing alone, each of the smaller advertisements were grouped together, the message impact would be even greater than that of the individual advertisements standing alone. This increased message impact, along with nine times the reach of the full-page advertisement, produces the most effective use of the advertising space and maximizes the cost-effectiveness of the advertisers' dollars.

The effectiveness of this advertising mechanism can be increased even further. As indicated above, concurrently with publication of the printed advertisements, a web site which is associated with the advertising layout can be provided. That is, a web site which is configured to present to users a replica of the printed advertising layout is provided. While the replica may vary slightly from the printed version of the advertising layout (e.g., to fit the slightly different aspect ratio of a computer display screen,) the arrangements of the smaller advertisements within the larger advertising layout remains the same between the printed and web-based versions. Thus, if a user views the printed advertisements and sees a space corresponding to a particular company in the lower, right-hand corner of the layout, he or she will find the advertisement for that company in the same general position on the web-based replica of the advertising layout. This effectively links the printed advertising layout to the web page and makes it easy for the user to locate information of interest on the web page.

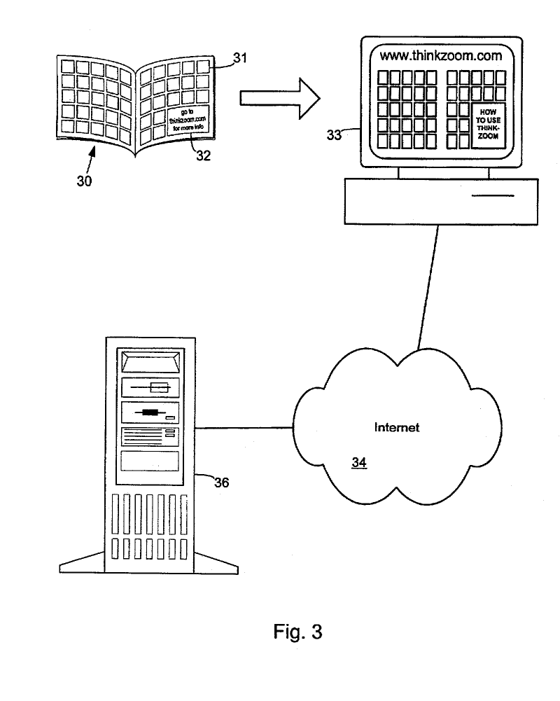

Referring to FIG. 3, a diagram illustrating the overall system is shown. In this figure, an advertising layout is contained in a printed publication 30 such as a magazine. The layout includes multiple small, individual advertisements (e.g., 31) as well as a section 32 which identifies a corresponding web site through which additional information can be obtained. Upon viewing the advertising layout, a reader may be interested in any one of the individual advertisements. In this case, the reader would access the Internet 34 via computer 33 to request the identified web page (e.g., www.thinkzoom.com) from server 36. In one embodiment, the requested page would comprise a replica of the advertising layout contained in the printed publication, although the replica could be somewhat modified (e.g., reduced in size, or changed in shape to fit the web page layout). The user could then select any of the objects on the web page to retrieve additional information through the corresponding link.

Referring again to the printed advertising layout illustrated in FIG. 2, the layout includes information which allows readers to find the web page which replicates the printed advertising layout. In a preferred embodiment, the reader is directed to a web site which may contain links to replicas of a number of printed advertisements. In this example, the reader is directed by banner 22 to the web site “Thinkzoom.com.” The print advertising layout may contain instructions which direct the reader to go to Thinkzoom.com and enter an identifier 23 which corresponds to the entire printed advertising layout. Identifier 23 may be identical for each of the magazines in which the printed advertising layout is published, or it may be unique for each of the magazines. If the same identifier is used, the identifier indicates that users of the web site who enter this number originated from the network of magazines in which the printed advertising layout was published. If unique identifiers are used, the particular magazine from which the user originated (hence the corresponding network of magazines) can be identified. Identifiers can be configured to indicate both the network of magazines and the individual magazine at the same time.

By identifying the magazine (or group of magazines) from which the user originated, certain demographic information corresponding to the user can be assumed. This demographic information can be readily obtained from various sources and may include very detailed information. For example, information maintained for readers in the financial magazine may include age, gender, education, average household income, average net worth, average value of portfolio, and so on.

Based upon the identification of a user's origin, the user can be provided with information which is tailored to his or her demographic information. For instance, while two users who are directed to the web site from different magazines may be presented with an identical image corresponding to the printed advertising layout, the HTML objects corresponding to particular smaller advertisements may be linked to different information for each of the users. In one embodiment, an advertisement for a travel agency may be linked to an offer for a tropical cruise if the user originated from the magazine Leisure Living, but the same advertisement may be linked to an offer for a hunting trip if the user originated from the magazine Field & Stream.

The identification of different users' demographics may also be used for a number of other purposes. For example, the demographics of the user may provide a basis for selecting a particular “skin” in which a web page is wrapped. A “skin” is, generally speaking, a package in which a page is presented to a user. The skin may be something as simple as a background color (e.g., a female demographic may be presented with a pink background, while a male demographic may be presented with a blue background,) or something more detailed, such as the arrangement of information items which are to be presented to the user. The users' demographics may also be used to determine which services are offered to a particular user, or to make various other modifications to the content which is provided to the user.

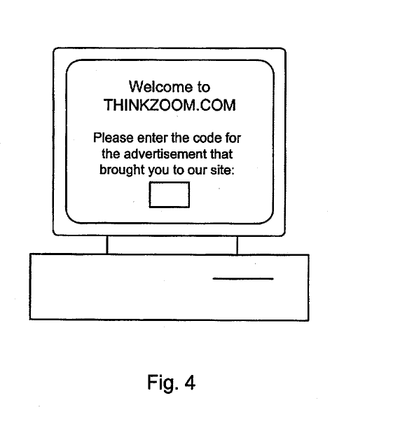

In the embodiment described above, in which a user who enters the identified web site address is presented in the first instance with the replica of the printed advertising layout, different web site addresses would need to be used to identify the user's origin and thereby provide demographic information. In another embodiment, a different mechanism is employed to obtain this information from the user. Similar to the embodiment described above, the printed advertising layout includes the name of a web site (e.g., Thinkzoom.com) to which the users are directed. In this embodiment, however, the layout also includes an identifier corresponding to the publication in which the advertising layout appears. Referring to FIG. 4, when a user enters the address of the web site into his or her browser, the homepage of the web site is retrieved. The homepage incorporates a prompt for the user to enter the identifier from the magazine. When the user enters this identifier, the web site service can retrieve information corresponding to the demographics associated with readers of that magazine. This may be accomplished using lookup tables or any other suitable mechanism. In one embodiment, the user is then presented with the replica of the printed advertising layout, wrapped in a skin selected for the user.

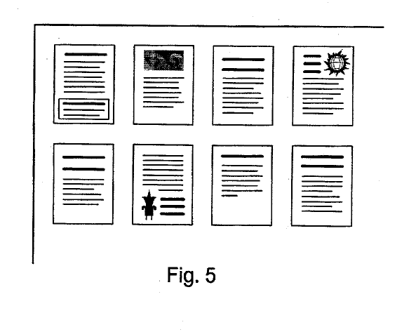

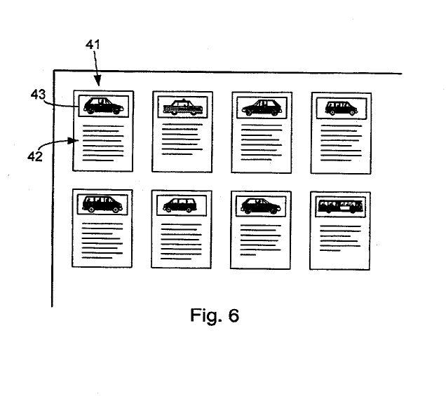

In the preferred embodiment, the web-based advertising layout has user selectable (“clickable”) advertisements corresponding to those in the printed advertising layout. These individual clickable advertisements may be equivalently referred to as objects or icons. Each of the advertisement objects in the web-based layout has a link which retrieves corresponding information when the advertisement is selected. Referring to FIGS. 5 and 6, exemplary advertisement objects are illustrated. In FIG. 5, a portion (the upper left-hand corner) of the advertising layout is shown. Each of the objects in this figure is essentially a single block that may contain text, trademark icons, and the like. Each block would typically describe the corresponding provider's goods or services. Each block has a single corresponding link to additional information. In FIG. 6, the upper left-hand corner of a layout is again shown, but in this embodiment, each of the individual advertisements consists of two parts, each of which has a separate link. The advertisements in this embodiment are directed to automobiles which are for sale. Each advertisement (e.g., 41) contains a textual description of the vehicle 42 that may, for example, be linked to the seller's contact information, as well as a small image 43 of the automobile that could be linked to a larger, more detailed image.

It should be noted that the link between the image or text and the additional information may be implemented in various ways. For example, the image or text may be hyperlinked to the additional info, so that when it is selected by “clicking” on it, the user is taken to a page identified by the hyperlink. As another example, the image or text may be linked to the information in such a way that the information is presented in a window whenever a cursor is positioned on the image or text (without clicking on it.) Other mechanisms may be used as well.

The user can then navigate through the web site, viewing the information associated with the advertisement in which he or she was originally interested, as well as any other information which the operator of the web site wishes to present. As the user navigates through the web site, the web site operator may collect additional information on the user. For example, the system may record the types of advertisements or information which are viewed by the user. This information may be used to augment the demographic data which was originally attributed to the user as a result of the user entering the magazine identifier. The augmented data may then be used to further refine the information which is presented to the user.

The present systems and methods may provide a number of advantages over prior art systems and methods. For example, because traffic is driven to the web site from small advertisements in a network of magazines or other publications, the cost of generating this traffic may be minimized. Further, because the web-based advertising layout is a replica of the printed advertising layout, it is easy for users to find the advertisements in which they are interested, and the users may be encouraged to navigate the web site more often or more extensively. Further, because the origination of the visitors to the web site can be traced to particular magazines, the amount of demographic data which may be associated with visitors to the web site may be increased. Further, because the small advertisements within the advertising layout can be linked to more extensive information than can be included in the small advertisement itself, the ability of advertisers to provide large amounts of information at a very low cost may be improved.

In one exemplary implementation of the present system, a layout in an appropriate group of magazines may contain excerpts from newly released books in a genre that would be of interest to the readers of those magazines. Interested readers could then access a web site identified in the layout and, through the objects in this layout, obtain descriptions of the books, further excerpts, authors' bios and lists of other works or publishers' information, or links to sites through which the books can be purchased.

In another implementation, a network of magazines designed for movie audiences (e.g., mass-market magazines such as People, Time, Newsweek or entertainment magazines) could include a layout with thumbnail versions of movie posters. Readers could then link to a web site in which the with thumbnail images of the movie posters are linked to descriptions of the movies, video trailers, and other movie-related information.

In another implementation, a layout with different vacation destinations could be published in an inappropriate network of magazines. If the vacation destinations were suitable for family vacations, the layout might appear in mass-market and/or family-oriented magazines. More exotic, upscale destinations might be found in a layout published in a network of travel/leisure or other lifestyle magazines. Readers then go to a web site identified in the printed layout and are presented with the replica of the printed layout. The reader can select individual destinations to link to images, video, descriptions, contacts, information on accommodations, or other travel-related information.

In another implementation, a layout containing listings of new models of automobiles might be published in a group of magazines designed to attract potential purchasers of new automobiles. When the readers go to the website identified in the layout, they can select objects in the web page layout corresponding to the automobiles in which they are interested. These objects could be linked to 360 degree views of the respective automobiles, features, interior views, descriptions, specifications, performance information, reviews, dealership locators and the like.

It should be noted that many other variations on the system described above are possible. For example, the system is not limited to print and web-based systems. The original advertising layout which attracts the attention of the user may be distributed via radio, television, billboard or other non-interactive (or less interactive) medium. This advertising layout may direct the user to view a web site, run an application on a CD-ROM, or interact with some other medium through which additional information can be obtained. The origination of the user's interest may also be indicated in other ways. The user may, for instance, be queried for certain information, such as age, sex, income level, and so on. In some embodiments, it is not necessary to go to the home page of the web site to enter the identifier from the printed advertising layout. The user may instead directly enter the web address of a page which contains a replica of the printed advertising layout. Alternatively, the user can enter a web page at which he or she can find the specific information associated with the advertisement of interest (without viewing the replica of the printed advertising layout.) These and many other variations are contemplated to fall within the scope of this disclosure.

The benefits and advantages which may be provided by the present invention have been described above with regard to specific embodiments. These benefits and advantages, and any elements or limitations that may cause them to occur or to become more pronounced are not to be construed as a critical, required, or essential features of any or all of the claims. As used herein, the terms “comprises,” “comprising,” or any other variations thereof, are intended to be interpreted as non-exclusively including the elements or limitations which follow those terms. Accordingly, a process, method, article, or apparatus that comprises a list of elements does not include only those elements but may include other elements not expressly listed or inherent to the claimed process, method, article, or apparatus.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

1. A method comprising
receiving in a web server a browser request containing a first identifier;
identifying demographic information associated with the first identifier; and
transmitting a first web page responsive to the browser request from the web server to a browser, wherein the first web page is customized according to the demographic information associated with the first identifier.

2. The method of claim 1, wherein the first identifier is contained in an address of the first web page.

3. The method of claim 2, wherein the request is a first-time request.

4. The method of claim 1, wherein the request is received in response to a prompt by the web server.

5. The method of claim 1, wherein customizing the first web page comprises customizing the form of the first web page, but not the substantive data of the first web page.

6. The method of claim 1, wherein customizing the first web page comprises customizing the substantive data of the first web page, but not the form of the first web page.

7. The method of claim 1, wherein the first web page comprises a replica of a printed advertising layout, wherein the printed advertising layout contains the first identifier.

8. The method of claim 7, wherein the first identifier is associated with a group of publications in which the printed advertising layout is published.

9. The method of claim 7, wherein the first identifier is associated with a single publication in which the printed advertising layout is published.

10. A system comprising:
a web server; and
a data storage coupled to the web server, wherein the data storage contains web pages;
wherein the web server is configured to receive a request from a browser, wherein the request includes a first identifier input by a user, wherein the identifier is associated with a first publication; and
wherein the web server is configured to identify a first web page associated with the first identifier, wherein the first web page includes a facsimile of a corresponding printed advertising layout, and
respond to the request with the first web page.

11. The system of claim 10, wherein the first web page contains a plurality of objects, each of which corresponds to an advertisement within the printed advertising layout.

12. The system of claim 11, wherein each of the plurality of objects has a corresponding link to additional information.

13. The system of claim 10, wherein the facsimile of the printed advertising layout contained in the first web page comprises a scaled replica of the printed advertising layout.

14. The system of claim 10, wherein the facsimile of the printed advertising layout contained in the first web page comprises an array of objects arranged in positions corresponding to advertisements within the printed advertising layout.

15. The system of claim 10, wherein the web server is configured to modify the first web page according to demographic information associated with the first identifier.

16. The system of claim 15, wherein the web server is configured to modify the first web page by selecting a skin for the first web page that is associated with the first identifier.

17. The system of claim 10, wherein the first identifier is contained in the address of the first web page.

18. The system of claim 10, wherein the first identifier is provided by the user in response to a query by the web server.

19. A method for increasing the reach of an advertisement comprising:
selecting at least one print advertisement;
reducing the size of the at least one print advertisement by a factor N; and
publishing the at least one reduced-size print advertisement in M publications.

20. The method of claim 19, wherein selecting at least one print advertisement comprises selecting a plurality of print advertisements, wherein the plurality of print advertisements are arranged in an advertising layout, and wherein publishing the at least one reduced-size print advertisement in M publications comprises publishing the advertising layout in the M publications.

21. The method of claim 19, further comprising selecting the M publications from a group of publications directed to readers in the same demographic.

22. The method of claim 19, wherein the at least one reduced-size print advertisement is published concurrently in the M publications.
